(19) United States
(12) Patent Application Publication
(10) Pub. No.: US 2008/0208703 A1
(43) Pub. Date: Aug. 28, 2008

(54) ONLINE COLLEGE BOOKSTORE

(76) Inventor: Dae W. Kim, Irvine, CA (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 11/679,605

(22) Filed: Feb. 27, 2007

(51) Int. Cl. G06Q 30/00

(52) U.S. Cl. 705/26; 705/1

(57) ABSTRACT

A system and method for distributing college textbooks on a college campus comprising the steps of locating unique indicia that is correlated with a unique college course. The unique college course is associated with at least one textbook having an ISB Number. Providing the located unique indicia to a first data location and extracting from the first data location the ISB Number associated with the unique indicia and utilizing the ISB Number to identify a college textbook, whereby the method and system allows a user to identify required college textbooks using only the unique indicia that is correlated with a unique college course.

### BACKGROUND

1. Field of the Invention

The present invention is related to simplified online retail sales and more specifically to online sales of college textbooks and related material.

2. Brief Discussion of Related Art

In past years college students engaged in a rite of passage each fall as they waited in line at the college bookstore. There they were greeted by confusing signs and harried sales associates who often did their best to be civil. In recent years, the “College Bookstore” of old has become a relic of a bygone era. Part of the revolution in the college book buying experience can be tied to the increased prevalence of the Internet and its associated booksellers. Websites like AMAZON.COM™ and eFOLLET.COM™ have pervaded the market with lower prices. Most of Students know that online bookstores, such as AMAZON.COM™ offer identical goods at a price that is lower than the price charged at the campus bookstore. However, students often find the online college book buying process to be difficult and confusing. In a usual scenario a shopper would first, visit campus bookstore and check title, edition, author, ISBN etc. This would usually be done several weeks before class starts. Thereafter, the student would go home and visit a site such as AMAZON.COM™ and find correct book, compare book price, check edition and ultimately order the textbook. Thereafter the student receives the book via a delivery service. Major problems facing existing online book suppliers include delivery problems and errors, wrong books, and long delivery times.

Another website CAMPUSBOOKS™ allows a user to search books by entering specific book information, such as title, author, publisher, ISBN, into a search field and then executing that search. This site serves as a clearinghouse for a variety of vendors and the site attempts to identify the lowest price retailer. Another entrant into the college bookstore market is VARSITYBOOKS™, which like eFOLLET.COM™ allows a user to find course appropriate books. The user selects the state, the college, and the desired course and the site identifies the appropriate book. In order to use this site the user selects the user's program, the user's term, the user department, the user's course, and the user's section. Once the selections are made, the user adds the book(s) to a virtual shopping cart and the books are subsequently delivered. Many of the same problems related to delivery problems and errors, wrong books, and long delivery times exist with these systems.

Many users are confused and overwhelmed by the amount of data that must be provided. A simpler solution would be desirable where a user would be able to identify their books using only one or two entries, which would be provided to the student in writing at the time of registration and where books ordered today would be in the possession of the user the next day.

### BRIEF SUMMARY OF THE DRAWINGS

The novel features believed characteristic of the invention are set forth in the appended claims. The drawing herein presented are representative and, unless otherwise stated, are not necessarily drawn to scale and should be used gain a better understanding of the embodiments and not to limit the embodiments. The invention itself, however, as well as a preferred mode of use, further objectives and advantages thereof, will best be understood by reference to the following detailed description of an illustrative embodiment when read in conjunction with the accompanying drawings, wherein:

FIG. 1 is an overview of one embodiment of the present invention;

FIG. 2 is a detailed view of the second database;

FIG. 3 is a detailed view of a user interface;

FIG. 4 is a sample display of a confirmatory page;

FIG. 5 is a typical interrelationship between the actor and the action when a student procures a textbook; and

FIG. 6 is one embodiment of the method of the present invention.

### SUMMARY OF THE INVENTION

One embodiment of the present invention provides system and method for distributing college textbooks on a college campus comprising the steps of locating unique indicia that is correlated with a unique college course. The unique college course is associated with at least one textbook having an ISB Number. Another step is to provide the located unique indicia to a first data location and extract the ISB Number associated with the unique indicia. Thereafter, the ISB Number can be utilized to identify a college textbook using only the unique indicia that is correlated with a unique college course.

In another embodiment the method for distributing college textbooks on a college campus includes the step of arranging for the conveyance of the college textbook from said first location, such as a warehouse to a second location such as a student's home or dorm. The present invention is designed to ensure that a textbook arrives at the second location, such as the student's home, within 36 hours of ordering. It is contemplated that the orders will be placed online.

Another embodiment of the present invention includes using a student representative who is enrolled in the school. This student representative acts as a liaison between the student body and the operator of the method for distributing college textbooks. Because the student is enrolled the student can closely follow college trends, quickly respond to student concerns, and can work closely with students who have concerns. The student representative can also serve as a first line for resolving issues and preserving trust and goodwill.

In another embodiment, the method for distributing college textbooks on a college campus includes the step of querying a second data location, such as an inventory list, to determine the availability of the college textbook in a first physical location, such as a warehouse. If an inventory list or other data location indicates that the textbook in question is out of stock, this embodiment automatically engages a search protocol, which seeks to identify an alternative physical location where the college textbook is available so that the order may still be fulfilled.

Another embodiment of the present invention provides a college textbook distribution system, which includes a user interface, which might include a touch screen, keypad, voice interface, or other interface system. The interface is operatively interconnected with a query type database and a college database. The query database is configured to parse data and send a query to the college database. The college database may be in the same physical location but it contains a listing of ISB Numbers correlated to the registration number. A local warehouse and a delivery system are also provided. To be clear, in this context “local” need not refer to a geographically local, but rather a temporally local database. It is contemplated that the student may be able to see an image of the textbook, have access to at least some textbook meta-data and some other information. While the present invention could be used in any college setting it is especially well suited to community colleges. In one embodiment, it is contemplated that a student would be able to pay for the student's textbooks though the students college account. This allows the student to pay for the books using the student's financial aid.

The local warehouse serves may be a residence that is near campus, or a trailer, or another non-conventional repository. Delivery may be made by a commercial provider or by another means. In some cases, the delivery may be to a central location or another agreed upon location where the books are distributed. Such location may be on campus or at a local gathering spot.

In another embodiment, the present invention includes a communication system that links a user interface, an electronically searchable database, a repository of college textbooks, a college textbook delivery system, and the warehouse. In this embodiment, the warehouse is situated so as to minimize burdens associated with delivery, and the user interface is configured to determine what constitutes an appropriate college textbook via the electronically searchable database using only college generated indicia.

### DETAILED DESCRIPTION OF THE PREFERRED EMBODIMENTS

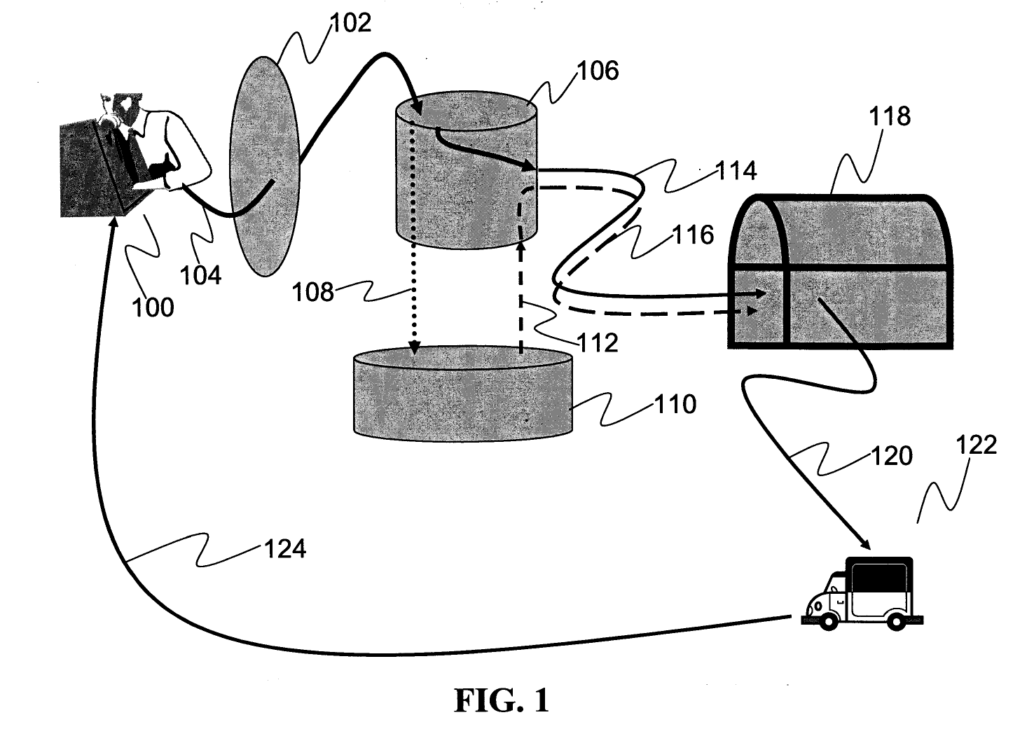

The present invention provides a system where a user can identify their books using a minimum of data entry, and books ordered today are delivered the next day. The invention provides an online bookstore specializing in college textbooks. The present invention is especially suited to smaller colleges and universities, including community colleges, but is equally applicable to larger institutions. While this specification is written in terms of textbooks, it should be understood that the principals employed herein may be extended to software, lab supplies, kits, and virtually any other class-required material. One key characteristic of the inventive system is an enormously simplified ordering process, and an efficient leveraging of commercial delivery systems coupled with a distributed warehouse network. The invention provides a customized website for each school. This website facilitates the ordering process by working closely with school databases. The bookstore procures and sells textbooks from a variety of sources, including the publisher. The secondary market (such as used textbooks) can also serve as a source of textbook inventory. FIG. 1 is an illustration of one embodiment of the present invention. A user 100 provides a first dataset 102 to a user interface 104 such interface 104 may be a keyboard, a telephone, or other device interconnected with a first database 106. The first database 106 parses the first dataset 102, isolating a first component relating to the user's school and class, such first component may be from the user's class registration document, and a second component relating to the user's shipping address. The first database 106 sends said first component 108 to a second database 110 the second database 110, relying on the provided first component 108 extracts desired textbook data 112. The textbook data 112 is conveyed to the first database 106 where it is used to create part of a query which comprises the textbook data 112 and user's shipping address. The query includes two components, the first query component 114 relates to warehouse proximity to the provided shipping address, and the second component 116 relates to specific textbooks. Thus, in the ideal case, a first warehouse 118 is situated proximal the shipping address and currently stores all the required books. The books are conveyed 120 to a truck 122 and delivered to the user 100. In the event that the first warehouse 118 does not stock one or more of the required books alternative warehouses may be queried and the books may be pulled from the alternative warehouses. If the alternative warehouse holds all the required books, a third party courier may be employed to deliver the books on an expedited basis. The user would still see the books in the previously agreed upon time slot. The database 110 specifies the textbook requirements by college, class, section, and professor. The information is all keyed to data, which is on the student's class registration form. In another embodiment, including the situation where the records are not publicly available an administrator may visit the bookstore and create the second database 110 from data gleaned from the college bookstore shelves.

The online bookstore of the present invention can be distinguished for the campus bookstore in a number of ways. Price, at least initially, is perhaps the most visible and critical component. The present invention procures textbooks from a variety of sources, including distributors, publishers, and the open market. In many cases, purchasing on the open market provides the best price, however availability also is a factor. The present invention contemplates procuring books form a variety of sources. The fungible nature of the textbooks, especially new textbooks, makes comparison-shopping very easy.

Reliable delivery is also a critical factor or continued existence in the business, and is important in distinguishing the present invention from other online retailers. Perceived reliability can be improved with up-to-the minute tracking information, and actual reliability can be ensured by using dependable systems, which are known for being on time. Certain commercial carriers have such reputations. One embodiment of the present invention provides that an order placed before 4 pm will be received the next day. A liberal return policy helps assure students that if they drop a class they can get their money back. Exceptions may exist for media related materials. A normal policy wound depend on the semester start date, the customer may be allowed up to one week after the first day of classes to return the books. This policy could be varied to coincide with tuition refunds, add drop deadlines or other college imposed academic dates. Product return, like delivery may be accomplished in a variety of ways including, mail, or direct contact with a customer service representative. If the product is to be shipped back, a shipping return label can be conveyed to the user in a variety of ways. In one embodiment, the pre-printed return labels are included with the original outbound goods. Alternatively, the return label may be mailed directly to the customer. In another embodiment, the label may be e-mailed to the customer. Once received, the returned product is processed as a single or multiple piece return shipment. Additionally, it may be desirable to associate a unique reference number with the item being returned. It is anticipated that the return process will allow returned items, which are still serviceable to be returned quickly and efficiently. The return process may be integrated with the distribution system and be linked directly with the customer service or warehouse operations. Customer service operations may contact students or otherwise determine why books are being returned, and the warehouse will use return data and customer service data in making determinations regarding inventory and purchasing.

One embodiment of the present invention is specifically focused on classes with high enrollment and that require high priced books and that using a common textbook. Target classes include: Math, Psychology, Speech, Spanish, Economics, Nursing Program Texts, Biology, Anthropology, Geology, Accounting, Chemistry, CIM. Other classes may similarly be well subscribed and the above list may not be common to all schools. The objective is to focus on textbooks where processing is simple and profit margins show the most promise. Because the present invention uses data indicating class enrollment it is possible to identify the classes of greatest promise. In general first and second year core classes and survey classes will show the most potential.

Advertising is another critical component of the present invention. In one embodiment, advertising may be accomplished using print flyers. The flyers may be customized by location be placed on cars in the parking lots that are close to the certain classes. More specifically, Science and Math parking lot could be targeted for an advertising campaign. The content of the advertisement could be customized to include the professor's name, the class sections, and even the specific textbook, including edition. The content could also be more generic allowing the advertisements to be used more widely. Custom printed pens are also used; these pens include contact information, such as the website and a brief description of our business printed on them. The description may be only three words. Advertisements are also placed in the classrooms that require target books. Professors are also made aware of the online bookstore and can tell students that this is an option for purchasing textbooks. More conventional advertising, such as classified advertisements in the School Newspaper, also provide visibility and attract customers. The school newspaper advertising could be run year-round. Internet Advertising is also an increasingly important medium, and especially so for the customer who will purchase textbooks online. In one embodiment, advertising is placed on popular college student websites, FACEBOOK.COM™, and RATEMYPROFESSOR.COM™ and MYSPACE.COM™, are all current example of popular sites.

The present invention's strengths include lower priced books as compared to campus bookstores, faster delivery than other online bookstores, a websites experience that is more user friendly and simpler to use. Strength is that customer service is tailored to individual campuses. The system is developed by students, for students and each campus will have at least one customer service representative for each campus.

As indicated above expediency is one hallmark of the present invention. This is accomplished with a distributed warehouse system. Referring more specifically to the warehouse 118 it is contemplated that the warehouse 118 be situated in the general proximity of one or more schools. The proximity facilitates easy distribution of textbooks in a timely and cost effective manner. The distribution may be done with the aid of a student who is seasonally employed to deliver the textbooks to each student's shipping address; alternatively, the textbooks may be delivered to the respective classrooms and distributed to students on the first day of class. In another embodiment, the textbooks are delivered to a predetermined dispensing location and students are scheduled to arrive at intervals to minimize the potential for waiting. A preferred scenario has the books delivered to the student's local shipping address. The shipping 124 could be done using a commercial shipping company such as UPS™ or the like, or with the aid of an improvised shipping and distribution system 124.

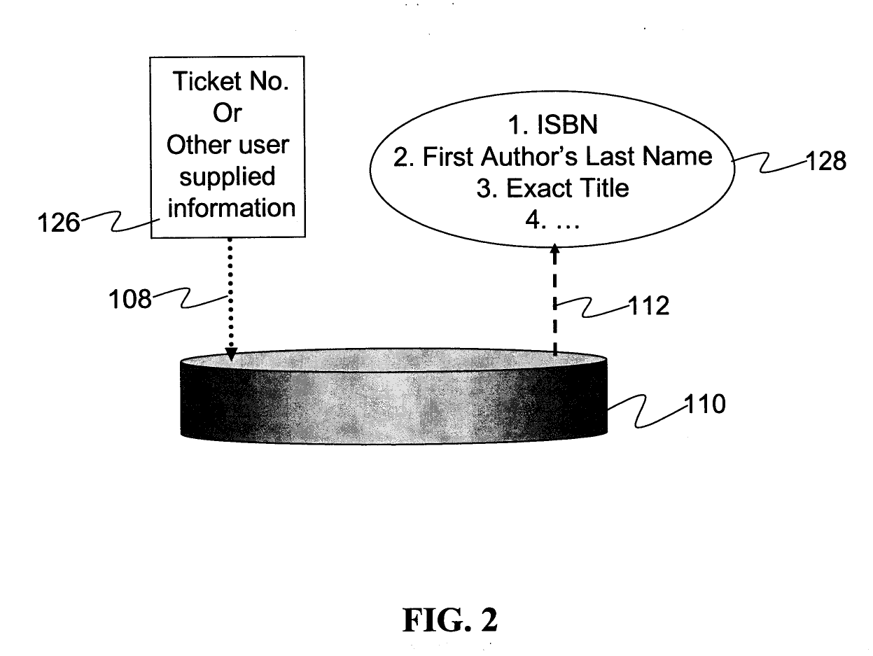

Referring to FIG. 2 which details more specifically to the second database 110, this database 110, in one embodiment, is tied to records provided by the school. In one embodiment, the records are indexed by a ticket number 126. The ticket number 126 is provided to the student at the time of enrollment. The ticket number correlates with, among other things, the textbook required for the unique class for which the student is enrolled. Thus, even if separate textbooks were required for separate sections, the database 110 would still correctly identify the appropriate textbook. The identification may be done by a variety of indicia 128, however, the International Standard Book Number or ISBN number would most commonly be selected. The ISBN number is a unique 10-digit number (soon to be 13) that identifies one title or edition of a title from one specific publisher and is unique to that edition. BOWKER™ is responsible for the assignment of the ISBN Publisher Prefix to U.S. publishers who are publishing their titles within the U.S.

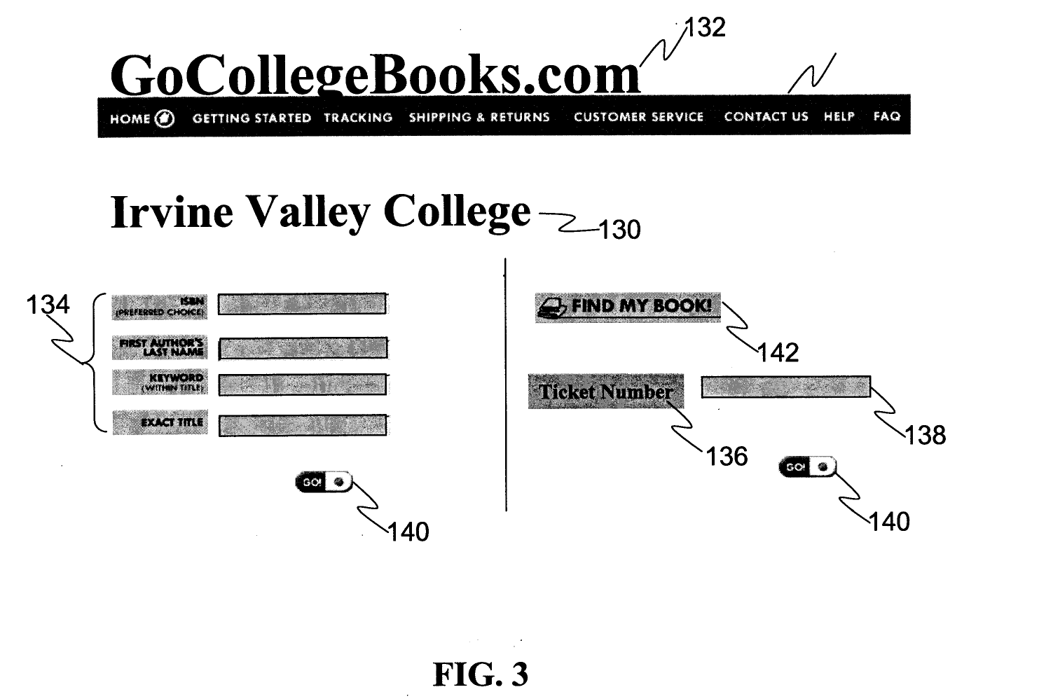

Referring now to FIG. 3, further describing the user interface, the user 100 navigates to the user's 100 school 130 portion of the website 132. The site allows a user to search using conventional criteria 134 or use the student's ticket number 136, which is provided to the student as a unique identifier associated with the student's registration. The student enters the ticket number 136 into field 138. The heading 142 indicates that this section of the page is specifically designed to accommodate the college student who is seeking a textbook.

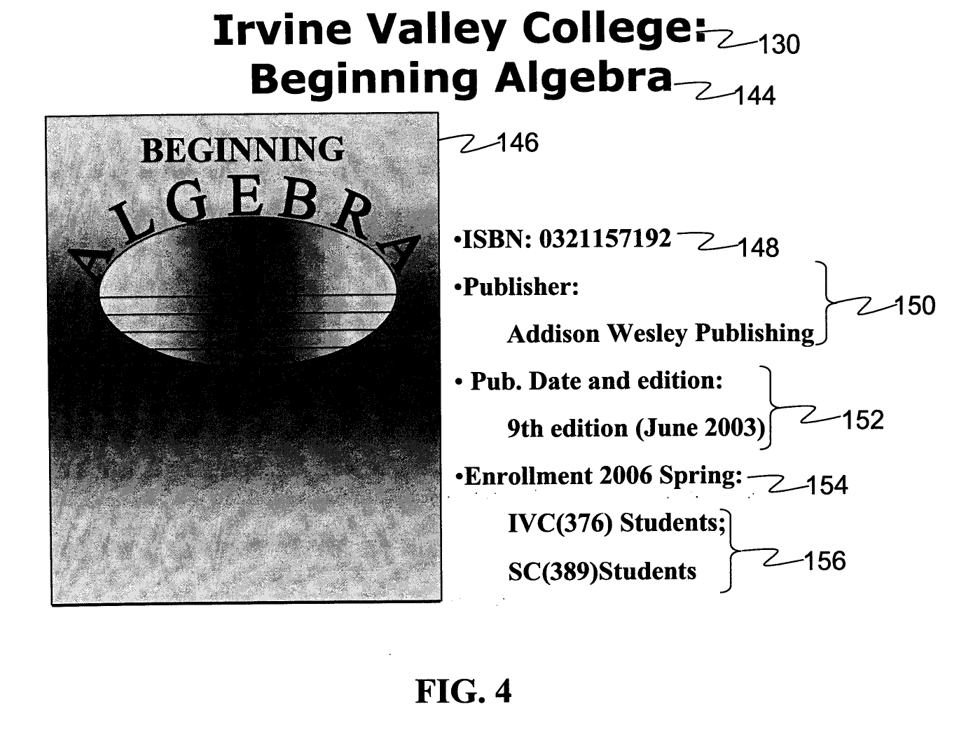

Referring now to FIG. 4 a student may be provided a confirmatory page displaying the school 130 the course title 144, a photograph of the book's cover 146 and various book data, including the ISBN number 148, the publisher 150, the publication data 152, the enrollment for the semester 154, and optionally the enrollment breakdown by campus 156. From time to time only parts of this information may be displayed or only parts of this data may be made available. In other cases, the data may be made available for a fee.

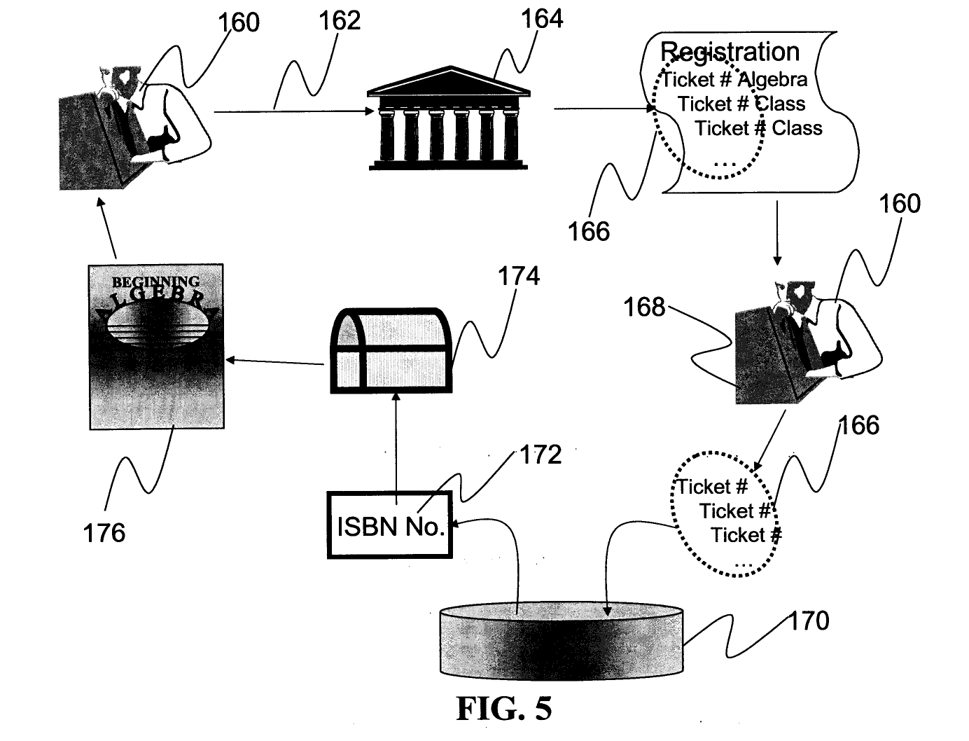

One embodiment of the present invention is provided in FIG. 5. The figure shows a typical interrelationship between the actor and the action when a student procures a textbook. The student 160 registers 162 for classes. This may be done in person, or more commonly electronically. The college 164 provides registration slip with ticket number 166. The student 160 accesses the inventive interface 168. The interface 168 accepts the input of ticket number 166 and in some embodiments the shipping address and payment information for the student 160. The ticket number 166 serves as the basis for query to the college textbook class requirement database, or college database 170. The college database 170 provides textbook identifying data including the ISBN number 172. The ISBN number 172 serves as the basis for identifying the correct textbook in the warehouse 174, the textbook 176 is then sent to the student 160. The student 160 receives correct textbook 176 promptly.

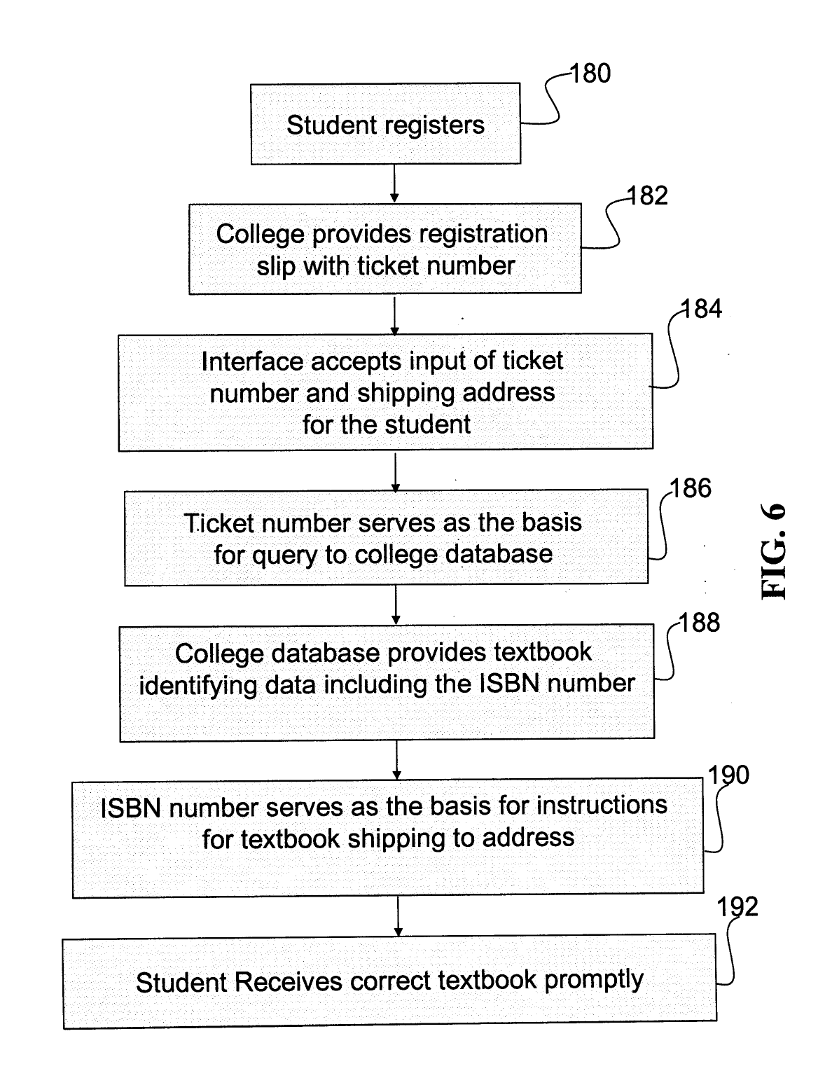

Referring now to FIG. 6 is an implementation of the method of the present invention. Where the student registers 180 and the college provides registration slip with ticket number 182. This may be provided electronically or via mail, or other means. The inventive interface accepts input of ticket number and shipping address for the student 184. Ticket number serves as the basis for query to college database 186. School database provides textbook identifying data including the ISBN number 188. The ISBN number serves as the basis for instructions for textbook shipping to address 190. Finally, the student receives correct textbook promptly 192.

It is contemplated that the online bookstore will query the college database or college textbook class requirement database for book ISBN numbers. The database may actually be stored on an online bookstore resident database and be periodically updated. The college textbook class requirement database or state database provides ISBN numbers for all college textbooks for upcoming semester. The ISBN Number serves as the basis for ordering textbooks. The textbooks are procured from a variety of suppliers. The suppliers include open market suppliers, publishers, distributors, booksellers, and others. All compete with the same product allowing for easy cost comparisons. The Cost comparisons serve as a factor in the purchasing decision.

The distribution system for the present invention includes, in one embodiment, provides that the textbooks are distributed using a shipping address and warehouse location. The warehouse locations are correlated with school locations. Book stock is correlated with the proximal school class requirements. The class requirements are determined by the college textbook class requirement database. The warehouse may take the form of a student representative's apartment. Distribution may occur through mailing, a book party, a set up on campus common areas or other desirable location.

Hallmarks of the current invention include, delivery speed, usually 24-48 hours. Speed is facilitated by relying on local distribution centers thus allowing for local deliver. Simplicity is evident throughout the inventive system. Of special note is the unique college website and the order system that only requires a ticket number, which is found on the students registration form or in the course catalog. Price is a significant factor in selecting a vendor. The present invention selects form a plurality of sources to identify the best-priced source. Price is also controlled by controlling costs, low overhead, and optionally free/low cost delivery means large savings. Delivery speed and good prices are meaningless if the right book is not delivered. The present invention relies on the same material that the campus bookstore relies on, thus the order is based on school instructions. No error is introduced by confusing bookstore signs. Local connection is an important part of the business; a student representative attends school and stays current on events of concern to the student body.

The following description, taken in conjunction with the referenced drawings, is presented to enable one of ordinary skill in the art to make and use the invention and to incorporate it in the context of particular applications. Various modifications, as well as a variety of uses in different applications, will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein. Furthermore, it should be noted that unless explicitly stated otherwise, the figures included herein are illustrated diagrammatically and without any specific scale, as they are provided as qualitative illustrations of the concept of the present invention. The description of the preferred embodiments has been presented for purposes of illustration and description, but is not intended to be exhaustive or limited to the invention in the form disclosed. Many modifications and variations will be apparent to those of ordinary skill in the art. The embodiments presented herein were presented in order to best explain the principles of the invention and its practical application, and to enable others of ordinary skill in the art to understand various embodiments and various modifications suited to a particular use.

I claim:

1. A method for distributing college textbooks on a college campus comprising the steps of:
locating a unique indicia that is correlated with a unique college course, wherein said unique college course is associated with at least one textbook having an International Standard Book Number;
providing the located unique indicia to a first data location;
extracting from said first data location the International Standard Book Number associated with the unique indicia;
utilizing the International Standard Book Number to identify a college textbook possessing that International Standard Book Number;
querying a second data location to determine the availability of the college textbook in a first physical location; and
arranging for the prompt conveyance of the college textbook to a second physical location;
whereby the method allows a user to identify required college textbooks using only the unique indicia that is correlated with a unique college course.

2. The method for distributing college textbooks on a college campus as set forth in claim 1, further comprising the step of:
arranging for conveyance of the college textbook from said first location to said second location, such that the college textbook arrives at the second location within 36 hours of providing the located unique indicia to the first data location.

3. The method for distributing college textbooks on a college campus as set forth in claim 1, further comprising the step of:
providing a website that is unique to a specific college and includes the college name.

4. The method for distributing college textbooks on a college campus as set forth in claim 1, further comprising the step of:
providing a student representative who is enrolled in the school as a liaison between the student and an operator of the method for distributing college textbooks on a college campus.

5. The method for distributing college textbooks on a college campus as set forth in claim 1, wherein the unique indicia correlated with a unique college course is associated with at least one textbook having an International Standard Book Number.

6. The method for distributing college textbooks on a college campus as set forth in claim 1, wherein the step of providing the located unique indicia to a first data location; includes the step of utilizing the Internet as a medium for conveying the located unique indicia.

7. The method for distributing college textbooks on a college campus as set forth in claim 1, wherein subsumed within the step of querying a second data location to determine the availability of the college textbook in a first physical location, is a protocol configured to identify an alternative physical location if the college textbook is not available at the first physical location.

8. A college textbook distribution system comprising:
a user interface;
a query type database;
a college database;
a local warehouse; and
a delivery system;
wherein a first dataset is provided, via a user interface, to the query type database, and the query type database queries the college database using the provided first dataset, the college database provides a second dataset to the query type database and the query type database parses the data and conveys the data to at least one proximally located warehouse.

9. The college textbook distribution system of claim 8 wherein:
said first dataset includes at least one of:
a college name;
a professor name;
a section number;
data on registration document; and a
a user shipping address.

10. The college textbook distribution system of claim 8 wherein:
said second dataset includes at least one of:
a college textbook title;
an International Standard Book Number;
an image of a college textbook;
an excerpt from a college textbook.

11. The college textbook distribution system of claim 9 wherein:
said second dataset includes at least one of:
a college textbook title;
an International Standard Book Number;
an image of a college textbook;
an excerpt from a college textbook.

12. A college textbook distribution system as set forth in claim 8 wherein:
the distribution system is used at a community college.

13. The college textbook distribution system of claim 8 wherein:
the user interface is a terminal and the query type database is in communication with the Internet and the user interface is configured to prompt a user to provide:
payment information for college textbooks;
shipping instructions for the college textbooks; and
special shipping instructions.

14. A college textbook distribution system as set forth in claim 13 wherein:
the payment information is tied to an account that the college maintains.

15. A college textbook distribution system as set forth in claim 8 wherein:
the local warehouse serves as a residence.

16. A college textbook distribution system as set forth in claim 8 wherein:
the local warehouse is a mobile container.

17. A college textbook distribution system as set forth in claim 8 wherein the delivery system includes from at least one of the following:
a commercial delivery provider;
a seasonal employee; and
a mobile warehouse.

18. A college textbook distribution system comprising:
a user interface;
an electronically searchable database;
a repository of college textbooks;
a college textbook delivery system; and
a communication system;
wherein the communication system links the user interface, the electronically searchable database, the repository of college textbooks, and the college textbook delivery system, the repository is situated to minimize burdens associated with delivery, and the user interface is configured to determine what constitutes an appropriate college textbook via the electronically searchable database using only college-generated indicia.

19 The college textbook distribution system of claim 18, wherein:
the communication system linking the user interface, the electronically searchable database, the repository of college textbooks, and the college textbook delivery system, uses the Internet.

20 The college textbook distribution system of claim 18, wherein:
the college-generated indicia is unique to each class.
